(19) United States
(12) Patent Application Publication
(10) Pub. No.: US 2004/0104547 A1
(43) Pub. Date: Jun. 3, 2004

(54) Pneumatic suspension system for vehicles

(76) Inventor: Richard L. McFarland, Canon City, CO (US)

Correspondence Address: HANES & SCHUTZ, P.C., 102 S. TEJON ST., SUITE 800, COLORADO SPRINGS, CO, 80903, US

(21) Appl. No.: 10/308,284

(22) Filed: Dec. 3, 2002

(51) Int. Cl. B60G 17/01

(52) U.S. Cl. 280/5.507

(57) ABSTRACT

A four point vehicular suspension system for a vehicle having left and right side frame members and spaced apart front and rear axles, comprising a plurality of lever beams having proximal and distal ends, a pair of which are each pivotally attached at their proximal ends, in spaced apart relationship, to each of the left and right frame members and attached at their distal ends to the front and rear axles, an expandable force-producing pneumatic bag disposed between each of the lever beams and the respective frame member to which the lever beam is pivotally attached, each bag being positioned between the proximal end and the distal end of each of the respective lever beams, and a source of air pressure and a valving system that is responsive to an unlevel position of the vehicle frame to selectively expand or contract the pneumatic bags to level the vehicle frame.

### FIELD OF THE INVENTION

The present invention relates to a suspension and leveling system for wheeled vehicles, especially cargo carrying vehicles, such as pick-up trucks.

### BACKGROUND OF THE INVENTION

Pneumatic devices that replace the traditional leaf, coil or torsion bar springs in vehicular suspension systems have been used in a variety of different configurations and are the subject of considerable prior art. While some of these prior systems could be constituted for a smaller vehicle such as a pick-up truck, most of the prior art involves complex systems that are designed for large load carrying vehicles, buses and recreational vehicles. The U.S. Patent to Heider et al., U.S. Pat. No. 4,923,210, is exemplary of a complex electrically controlled pneumatic suspension system that is unnecessarily complex for use on a smaller vehicle, either as original equipment or as an after-market retrofit.

The primary object of the present invention is to provide a simple pneumatic vehicular suspension system that can be retrofitted into the standard leaf, coil or torsion spring-shock absorber type of suspension system in most small-load carrying vehicles.

A second object of the invention is to provide a suspension system for vehicles that will be instantly responsive to changes in forces acting on the vehicle so as to make the necessary adjustments in the suspension system to level the vehicle and prevent tilting or pitching as a function of load distribution, acceleration, deceleration or turning of the vehicle.

Other and further objects, features and advantages of the present invention will become apparent as the description of the invention proceeds.

### SUMMARY OF INVENTION

The vehicular suspension system of the present invention is intended to replace the traditional leaf, coil or torsion bar spring suspension system, either as original equipment or as a retrofit of the original structure of the vehicle. Vehicles intended for application of the present invention are those having a pair of spaced apart, longitudinally extending and laterally interconnected vehicular frame members and front and rear wheel axles variably spaced apart from the frame members and generally perpendicular thereto.

In the combination of the present invention, the left and right vehicle frame members and the front and rear axles are each pivotally interconnected with third class lever beams. In contact with a point intermediate the fulcrum of each lever beam and the distal location on the lever beam to which the axle is attached is one side of an expandable pneumatic bag that provides a force component to the lever. The other side of each expandable pneumatic bag is in contact with the vehicle frame. A source of air pressure acts through an air intake valve to inflate the pneumatic bag to increase the distance between the vehicle axle and the vehicle frame when such increase is required to level the vehicle body. A vehicle body-position sensor controls the air intake valve. The vehicle posture sensor also actuates an air exhaust valve to allow deflation of a respective one of the pneumatic bags when decreasing the force between the vehicle frame and the lever beam is necessary to level the vehicle body.

### DESCRIPTION OF THE DRAWINGS

FIG. 1 is a diagrammatic side view of the suspension system of the present invention for both the left and right sides of the vehicle frame.

FIG. 2 is a diagrammatic bottom view of a typical vehicle frame, with front and rear wheel axles, that incorporates the suspension system of the present invention.

FIG. 3 is a diagrammatic front view of the front axle of a vehicle incorporating the suspension system of the present invention with the left and right frame members shown in cross section.

FIG. 4 is a diagrammatic rear view of the rear axle of a vehicle incorporating the suspension system of the present invention with the left and right frame members shown in cross section.

### DETAILED DESCRIPTION OF THE INVENTION

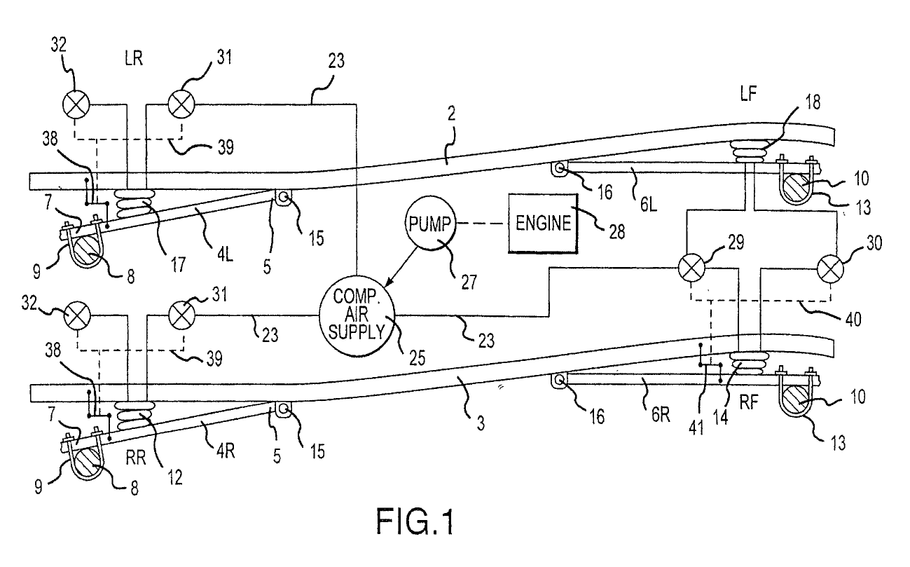

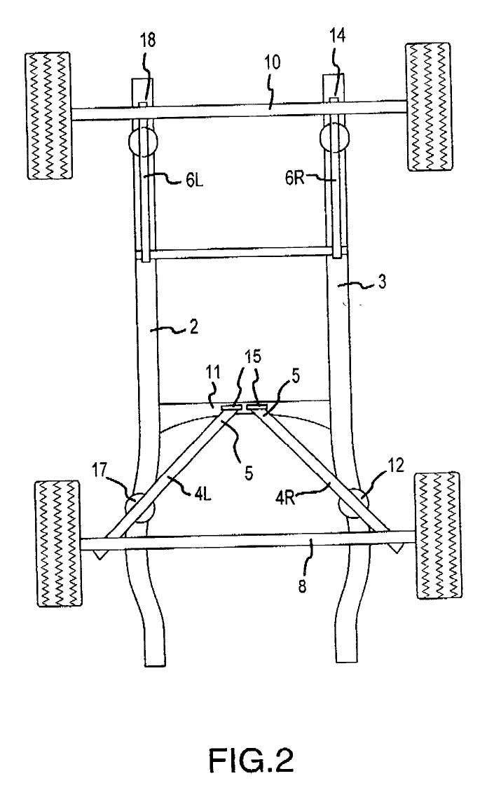

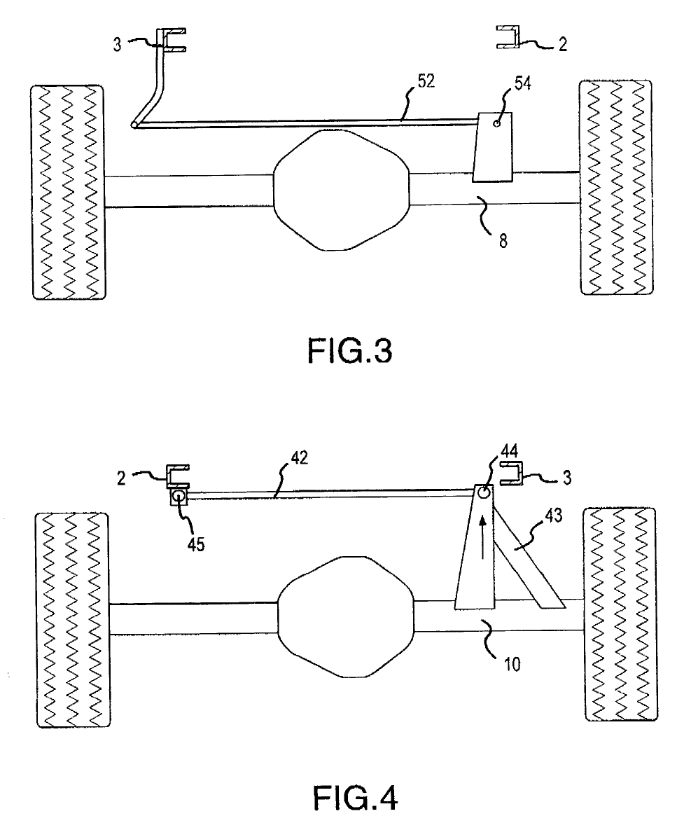

Referring first to FIG. 1, a typical pick-up truck frame comprising left and right side members 2 and 3 is diagrammatically shown. Spaced apart rear and front wheel mounting axles 8 and 10 are positioned perpendicularly to the left and right frame members. The axles are disposed below the frame members and spaced therefrom, as seen in the side views shown in FIG. 1. The vehicle whose frame is depicted in FIGS. 1 and 2 does not include the traditional leaf springs that traditionally interconnect the vehicle frame with the wheel axles to form a suspension system. Shock absorbers are intended to be included in the suspension system of the present invention but are not shown on the drawings.

In the suspension system of the present invention the left and right side frame members 2 and 3 of the vehicle are connected to the vehicle's rear axle 8 by a pair 4L and 4R of rigid lever beams. Another pair 6L and 6R of rigid lever beams connects the respective left and right vehicle side frame members to the vehicle's front axle 10. The exact layout of the lever beams with respect to the vehicle frame will depend on the particular vehicle frame structure, however for a frame design similar to the one shown in FIG. 1, the lever beam arrangement shown in FIG. 1 is preferable. The rear lever beams 4L and 4R are connected at their respective fulcrum-forming ends 5 with a pivotal connection 15 to the central portion of a cross frame member 11. The rearmost distal ends 7 of the rear lever beams 4L and 4R are spread from their points of connections to the frame member 11 to form a “V,” with their distal ends 7 extending respectively over the left and right end portions of the rear axle 8. The distal end 7 of each lever beam 4 is attached to the axle 8 with a “U” clamp 9.

The lower side of an expandable pneumatic bag 12 is in contact with the lever beam 4R at a point intermediate the beam's pivotal connection 15, at its fulcrum end, and the point at which the lever beam is attached to the axle with the clamp 9. The opposing upper side of the expandable pneumatic bag 12 is disposed against the underside of the side frame member 3, as shown in FIG. 1, in order to provide an expansion force to separate the frame member and the lever beam between which the bag is located. The fact that the force element, the pneumatic bag, is intermediate the fulcrum 15 and the load (axle), the each lever beam becomes a third class lever.

The rear portion of the left side frame member 2 is assembled with an expandable pneumatic bag 17 and left lever beam 4L, similarly to the described right rear lever beam 4R and the right rear portion of the frame member 3.

The pneumatic bags act in some manner as shock absorbers but are primarily intended to provide the force that spreads the side frame members 2 and 3 from their respective lever beams 4L and 4R to effect a leveling of the vehicle. The pneumatic bags are arranged to allow them to deflate in order to remove the expansion forces and thereby allow the spaces between the frame members and the lever beams to contract, as will be subsequently explained.

While functionally similar to the rear axle-frame interconnections, the front axle is suspended from the front portion of the right and left side frame members 3 and 2 by pivotal lever beams 6R and 6L that are mutually parallel, as seen best in FIG. 2. Each of the front lever beams are pivotally interconnected to their respective frame members 2 and 3 by connections 16. The front lever beams 6R and 6L are respectively attached to the right and left ends of the front axle 10 by U clamps 13. Expandable pneumatic bags 14 and 18 are disposed between the right and left lever beams 6R and 6L and the right and left side frame members 3 and 2 in the same manner as with the rear pneumatic bags 12 and 17.

The pneumatic bags 12, 17, 14 and 18 are supplied with pressurized air through air lines 23 connected to a compressed air tank 25 and an associated air pump 27 that is driven by the vehicle's engine 28. Air pressure is maintained at an appropriate level in the tank 25 by conventional means (not shown in the drawings) of pressure sensing and associated switching to turn the air pump on and off.

Prior to an explanation of the valve system that regulates air pressure in the pneumatic bags it is helpful to understand the function of the air bags vis-à-vis the invention's objective to maintain a level vehicle posture notwithstanding the loading, vehicle acceleration, deceleration or turning forces acting on the vehicle. A heavy load in the bed of a pick-up truck tends to lower the rear end and elevate the front end of the vehicle. Turning forces tend to tilt the body and frame. Acceleration tends to raise the front end while deceleration forces the front end down. Because the truck handles and responds to control better with a level body, it is desirable to maintain it in that position. But, expanding the pneumatic bags to spread the specified frame and lever beams and by allowing specified pneumatic bags to exhaust air and deflate, the vehicle frame can be kept in the desired level position. The valving system of the present invention is intended to implement the expansion and accommodate the contraction of the pneumatic bag or bags to execute the leveling operation. If a load exhibits greater weight on one side of the truck than the other, or in a turn, the truck body tends to tilt, or rotate about its longitudinal axis, the sensors for the valving system operate to actuate a specific valve to either allow a bag to be inflated or deflated so for example, the low side of the vehicle will be raised and the high side will be allowed to descend.

The front of the vehicle is not as susceptible to load induced posture variations as the rear, however the front of the vehicle is inclined to dip on deceleration and raise on acceleration. The reverse is true of the rear end. Accordingly, a combined valve arrangement is provided for the two front pneumatic bags 14 and 18. However, each of the front bags could easily be connected to their own individual valves, as do the rear pneumatic bags.

Because each of the pneumatic valves must admit air pressure to expand or pump up the bag, an intake valve is necessary to admit pressurized air through the air lines 23 from the compressed air tank 25. Similarly, when the leveling of the vehicle requires compression of one or more of the pneumatic bags, an exhaust valve is necessary to allow pressurized air to escape from the bag.

In the preferred embodiment of the invention, as illustrated in the drawings, each of the rear bags 12 and 17 have their own individual intake and exhaust valves. The intake and exhaust valves may be housed in one valve body but for illustrative purposes they are shown in FIG. 1 as two separate valves 31 and 32. In the preferred form, only one set of intake and exhaust valves 34 and 36 is shown for controlling the air in the front pneumatic bags 14 and 18. The mechanical actuation lever 38 for the left rear intake and exhaust valves 31 and 32 is similar to the same lever for both the right rear valve set 31 and 32 and to the front valve set 34 and 36. The explanation for one set of valves will serve as an explanation of all three sets that are shown in FIG. 1.

Exemplary of all valve sets is the set of valves that controls the inflation of the left rear pneumatic bag 17. In the preferred embodiment the center portion of the lever 38 is connected by mechanical attachment 39 to the intake and exhaust valves 31 and 32. When the frame member 2 is depressed by a cargo load in the bed of the truck the center portion of the lever 38 is rotated, moving the attachment 39 to open the intake valve 31 and admit additional pressurized air to expand the bag 17 and raise the rear portion of the left frame member 2. Simultaneously, when the left side is initially depressed the right rear side of the frame 3 tends to rise. This lifting the right side 3 of the vehicle frame causes the center portion of the right rear lever 38 to rotate in a direction opposite to the rotation explained for the center portion of the left rear sensing lever 38, causing the exhaust valve 32 to open and allow pressurized air in the pneumatic bag 12 to escape, letting the right rear frame of the vehicle to be lowered. A level truck body position would represent a neutral position of the mechanical sensor 38.

The pneumatic bags 14 and 18 in the front of the vehicle are simultaneously pumped up and exhausted, utilizing the single sensor lever 41 to control the linkage 40 that activates the intake and exhaust valves 31 and 32 for the front end of the vehicle. The sensor lever 41 operates in a similar fashion to the sensor levers 38 in the rear of the vehicle, that is sensing the elevation or dipping of the front end and admitting additional air pressure to pump up the left and right front pneumatic bags or allowing the bags to simultaneously deflate and lower the front end of the vehicle.

In order to maintain lateral stability of the vehicle body with respect to the front and rear axles, stabilizers are provided in the form of rigid tracking arms 42 and 52. The rear tracking arm 42 is pivotally attached at one of its ends 44 with a bracket 43 to the rear axle 10. The other end 45 of the arm 42 is pivotally attached to the frame member 2. The front tracking arm 52 is pivotally attached at one of its ends 54 to the front axle 8. The other end 55 of the arm 52 is pivotally attached to the frame member 3. The pivotal connections allow the front and rear axles to move vertically with respect to the frame members 2 and 3 but the tracking bars 42 and 52 maintain lateral stability between the vehicle frame and the front and rear axles.

What is claimed is:

1. In an air cushion suspension and leveling system for wheeled vehicles that have first and second longitudinally extending and laterally interconnected vehicular frame members and front and rear wheel axles variably spaced apart from the frame members and positioned generally perpendicular thereto, the improvement comprising,
front and rear rigid third class lever beams each having a fulcrum pivotally attached to the first frame member and each being attached to the respective front and rear wheel axles,
front and rear rigid third class lever beams each having a fulcrum pivotally attached to the second frame member and each being attached to the respective front and rear wheel axles,
a pneumatic bag disposed between each lever beam and the respective frame member to which each lever beam is attached, said bag being in contact with the lever beam at a point between the fulcrum of the lever beam and the point of attachment of the lever beam to the respective wheel axle,
a source of air pressure,
a plurality of intake valve means fluidly interconnecting the air pressure source and each of the pneumatic bags,
a plurality of exhaust valve means interconnected to each of the pneumatic bags,
a like plurality of mechanical levers, each operably connected to a respective one of the intake and exhaust valve means and responsive to the variable spacing between the vehicle frame and axles to actuate the respective valves.

2. The combination of claim 1 and further including a front tracking arm pivotally interconnecting the front wheel axle and one of the vehicle frame members.

3. The combination of claim 2 and further including a rear tracking arm pivotally interconnecting the rear wheel axle and one of the vehicle frame members.

4. A four point vehicular suspension system for a vehicle having left and right side frame members and spaced apart front and rear axles, comprising,
a plurality of lever beams having proximal and distal ends, a pair of which are each pivotally attached at their proximal ends in spaced apart relationship to each of the left and right frame members and attached at their distal ends to the front and rear axles,
an expandable force-producing pneumatic bag disposed between each of the lever beams and the frame member to which the lever beam is pivotally attached, said bag positioned between the proximal end and the distal end of each respective lever beam.

5. The suspension system of claim 4 and further including,
a source of air pressure,
a plurality of air intake valves interconnecting the source of air pressure and each of the pneumatic bags,
first linkage means interconnecting the frame members and the lever beams to sense relative movement between a frame member and a lever beam pivotally connected to the frame member, and
second linkage means responsive the first linkage means to open at least one of the intake valves when the frame member is depressed toward the axle to which the lever beam is attached.

6. The suspension system of claim 5 and further including,
a plurality of air exhaust valves connected to each of the pneumatic bags, and
third linkage means responsive to the first linkage means to open at least one of the exhaust valves when the frame member is raised away from the axle to which the lever beam is attached.
